(19) United States
(12) Patent Application Publication
(10) Pub. No.: US 2011/0109737 A1
(43) Pub. Date: May 12, 2011

(54) NAVIGATION APPARATUS AND METHOD FOR RECORDING IMAGE DATA

(76) Inventors: Sjoerd Aben, Alkmaar (NL); Erik Thomassen, Amsterdam (NL); Teun De Haas, Utrecht (NL)

(21) Appl. No.: 12/736,946

(22) PCT Filed: Oct. 8, 2008
(86) PCT No.: PCT/EP2008/063482

§ 371 Date: Jan. 25, 2011

(51) Int. Cl. H04N 7/18; G06K 9/00

(52) U.S. Cl. 348/113; 382/103; 348/E07.086

(57) ABSTRACT

A navigation apparatus includes an image recording device for recording image data and a processing resource configured to receive an incident signal indicative of the occurrence of an incident and to perform an image data processing operation in response to the incident signal.

### FIELD OF THE INVENTION

The present invention relates to navigation apparatus, and in particular to navigation apparatus that includes or is linked to an image recording device. The invention also relates to a method of recording image data using a navigation apparatus.

### BACKGROUND TO THE INVENTION

Portable computing devices, for example Portable Navigation Devices (PNDs) that include GPS (Global Positioning System) signal reception and processing functionality are well known and are widely employed as in-car or other vehicle navigation systems.

In general terms, a modern PND comprises a processor, memory (at least one of volatile and non-volatile, and commonly both), and map data stored within said memory. The processor and memory cooperate to provide an execution environment in which a software operating system may be established, and additionally it is commonplace for one or more additional software programs to be provided to enable the functionality of the PND to be controlled, and to provide various other functions.

Typically these devices further comprise one or more input interfaces that allow a user to interact with and control the device, and one or more output interfaces by means of which information may be relayed to the user. Illustrative examples of output interfaces include a visual display and a speaker for audible output. Illustrative examples of input interfaces include one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device by touch.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favorite or recently visited destinations.

PNDs of this type may be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of software on the device to perform both route calculation and navigation along a calculated route.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information may be displayed, optionally in a status bar above, below or to one side of the displayed map information, examples of navigation information include a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route.

Although the route calculation and navigation functions are fundamental to the overall utility of PNDs, it is possible to use the device purely for information display, or “free-driving”, in which only map information relevant to the current device location is displayed, and in which no route has been calculated and no navigation is currently being performed by the device. Such a mode of operation is often applicable when the user already knows the route along which it is desired to travel and does not require navigation assistance.

Devices of the type described above, for example the 920T model manufactured and supplied by TomTom International B.V., provide a reliable means for enabling users to navigate from one position to another. Such devices are of great utility when the user is not familiar with the route to the destination to which they are navigating.

As mentioned above, it is known to provide data from real time traffic monitoring systems to portable navigation devices, enabling the portable navigation devices to monitor traffic conditions. However, such real time traffic monitoring systems are usually based upon the monitoring of traffic at fixed locations, usually traffic hotspots. The effects of a serious traffic incident may be noticed by such monitoring as such effects of would usually be felt across a wide area of a traffic network. However, such traffic monitoring systems are of less use in monitoring the effects of more minor incidents occurring away from traffic hotspots. Furthermore, known traffic monitoring systems are generally not effective in monitoring the causes of an accident or other traffic incident, instead they monitor the after-effects of such incidents on traffic flow. The police generally have a small time frame to perform technical reconstruction of accident evidence left at a scene, and often have problems in determining the cause of road accidents, in particular who was at fault. At best, they may have eyewitnesses, who may or may not be reliable, or, possibly, sporadic camera coverage recorded by a building's CCTV or ATM footage to assist them in determining the causes and details of an accident or other incident.

### SUMMARY OF THE INVENTION

According to a first aspect of the present invention, there is provided a navigation apparatus comprising:—an image recording device for recording image data; and a processing resource configured to receive an incident signal indicative of the occurrence of an incident and to perform an image data processing operation in response to the incident signal.

Thus, a navigation apparatus may be controlled to respond to the occurrence of an incident. The navigation apparatus may comprise a portable navigation device, and the image recording device may be included in the portable navigation device, or may be separate but operably linked to the portable navigation device. The processing resource may comprise control circuitry for controlling operation of the image recording device.

The navigation apparatus may be installed in a vehicle. The incident may be a traffic incident, for example a traffic accident. The navigation apparatus may provide the capability to start recording (or to keep existing footage) within the vicinity of a location during a particular time period, upon request.

The image data may comprises video data, and the image recording device may be a video recording device. Alternatively or additionally, the image data may comprise still image data. The image data processing operation may comprise a transmission or recording operation. The transmission or recording operation may comprise at least one of transmitting image data to a server, recording image data and retaining recorded image data.

The navigation apparatus may be configured such that the image recording device records image data continuously or periodically as part of its normal operation. In that case, the image data processing operation may comprise retaining and/or transmitting previously recorded image data. Thus, image data obtained before or at the time of an incident may be retained and/or transmitted for further processing or storage. The navigation apparatus may be configured such that image recording is started in response to a trigger, for instance recognition of a certain element on the road (for example a traffic sign, such as stop sign or give way sign) or behaviour of a driver or vehicle (for example sharp braking) or presence of a predetermined vehicle type (for example a police car).

The image recording device may have a limited storage capacity, and may store data on a first in first out basis, with earlier data being overwritten. In that case, initiation of the retention of recorded image data may comprise ensuring that the data is not overwritten. The image recording device may be configured to increase the amount of memory allocated for storage of image data.

The navigation apparatus may comprise communication circuitry for transmitting and/or receiving data, and preferably the communication circuitry is configured to enable communication between the navigation apparatus and the server and/or other navigation apparatus. The control circuitry may comprise a suitably programmed processor.

The navigation apparatus may be configured to receive the incident signal from a a source external to the apparatus or to a vehicle in which the apparatus may be installed, for example a server. The processing resource may be configured to control operation of the image recording device and/or the communication circuitry in response to the incident signal so as to perform the image data transmission or recording operation.

The navigation apparatus may comprise detection circuitry for detecting the occurrence of the or an incident, and for generating the or an incident signal in response to the occurrence of the or an incident. The navigation apparatus may be installed in a vehicle, and the detection circuitry may be arranged to detect movement of the vehicle, and to generate the incident signal in response to a movement of the vehicle. The detection circuitry may be arranged to generate the incident signal in response to an abnormal movement of the vehicle, which may comprise at least one of an acceleration, a deceleration, a turning, a skid, or a shock.

The navigation apparatus may be configured to transmit the incident signal to a server and/or to at least one other navigation apparatus.

Preferably the incident signal is such as to cause the at least one other navigation apparatus to perform an image data processing operation. Thus, incident monitoring by a plurality of navigation apparatuses may be established without requiring instruction from a server.

In the case where the incident signal is transmitted to a server, the server may, in response, be configured to retransmit the incident signal or to transmit a further incident signal to at least one other navigation apparatus, for initiating an image data processing operation.

The processing resource may be configured to record and/or transmit further data in response to the incident signal. The further data may comprise at least one of data representative of at least one of light level, speed, temperature, or a weather condition. The further data may comprise data representative of operation of the vehicle or a component of the vehicle. The further data may comprise CANbus data.

The navigation apparatus may comprise a vehicle or number plate recognition module, the incident signal may comprise a vehicle identifier, and the image data processing operation may comprise instructing the vehicle or number plate recognition module to analyse the image data for the presence of a vehicle or number plate in dependence upon the vehicle identifier.

In a further independent aspect of the invention there is provided a server comprising an incident monitoring module configured to transmit an incident signal to at least one navigation apparatus in response to the occurrence of an incident, the incident signal being for initiating an image data processing operation at the at least one navigation apparatus.

The incident signal may comprise at least one of a navigation apparatus identifier and a location identifier. Each navigation apparatus may carry out the image data processing operation in dependence upon whether its identity or location matches the navigation apparatus identifier or the location identifier. Thus, the navigation apparatuses that are used to record or transmit data of the incident may be selected.

The image data processing operation may comprise a transmission or recording operation and preferably comprises at least one of transmitting image data to the server, recording image data and retaining recorded image data.

The server may be configured to receive image data from the at least one navigation apparatus and to process the image data in response to the occurrence of the incident.

The server may further comprise a vehicle or number plate recognition module, wherein the processing of the image data comprises analysing the image data by the vehicle or number plate recognition module to identify at least one vehicle or number plate associated with the incident. The processing of the image data may comprise processing image data to track the identified vehicle or number plate.

In a further independent aspect of the invention there is provided a navigation system comprising a server comprising an incident monitoring module configured to transmit an incident signal in response to the occurrence of an incident, and at least one navigation apparatus, the or each navigation apparatus comprising an image recording device for recording image data and a processing resource configured to receive the incident signal and to perform an image data processing operation in response to the incident signal.

In another independent aspect of the invention there is provided a method of monitoring the scene of an incident comprising recording image data using at least one navigation apparatus at the scene of the incident.

The method may further comprise transmitting the recorded image data from the or each navigation apparatus to a server.

The modules mentioned herein may be implemented in software or hardware or any suitable combination thereof. Different modules may be combined as a single module. Alternatively or additionally, the functionality of any individual module may be provided by a combination of sub-modules, which may be implemented on a single processor or platform or may be distributed across a plurality of distinct processors or platforms.

Any feature in one aspect of the invention may be applied to other aspects of the invention, in any appropriate combination. In particular, apparatus features may be applied to method features and vice versa.

### BRIEF DESCRIPTION OF THE DRAWINGS

At least one embodiment of the invention will now be described, by way of example only, with reference to the accompanying drawings, in which:

FIG. 1 is a schematic illustration of an exemplary part of a Global Positioning System (GPS) usable by a navigation device;

FIG. 2 is a schematic diagram of a communications system for communication between a navigation device and a server;

FIG. 3 is a schematic illustration of electronic components of the navigation device of FIG. 2 or any other suitable navigation device;

FIG. 4 is a schematic diagram of an arrangement of mounting and/or docking a navigation device;

FIG. 5 is a schematic representation of an architectural stack employed by the navigation device of FIG. 3;

FIG. 6 is a schematic illustration of a navigation system in which the navigation device of FIG. 3 is operably connected to an image recording device;

FIG. 7 is a schematic illustration of a variant of the navigation system of FIG. 6; and

FIG. 8 is a flow chart illustrating one mode of operation of the systems of FIGS. 6 and 7.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings of the present invention are not limited to PNDs but are instead universally applicable to any type of processing device. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention have utility in circumstances where a user is not seeking instructions on how to navigate from one point to another, but merely wishes to be provided with a view of a given location. In such circumstances the “destination” location selected by the user need not have a corresponding start location from which the user wishes to start navigating, and as a consequence references herein to the “destination” location or indeed to a “destination” view should not be interpreted to mean that the generation of a route is essential, that travelling to the “destination” must occur, or indeed that the presence of a destination requires the designation of a corresponding start location.

With the above provisos in mind, the Global Positioning System (GPS) of FIG. 1 and the like are used for a variety of purposes. In general, the GPS is a satellite-radio based navigation system capable of determining continuous position, velocity, time, and in some instances direction information for an unlimited number of users. Formerly known as NAVSTAR, the GPS incorporates a plurality of satellites which orbit the earth in extremely precise orbits. Based on these precise orbits, GPS satellites can relay their location to any number of receiving units.

The GPS system is implemented when a device, specially equipped to receive GPS data, begins scanning radio frequencies for GPS satellite signals. Upon receiving a radio signal from a GPS satellite, the device determines the precise location of that satellite via one of a plurality of different conventional methods. The device will continue scanning, in most instances, for signals until it has acquired at least three different satellite signals (noting that position is not normally, but can be determined, with only two signals using other triangulation techniques). Implementing geometric triangulation, the receiver utilizes the three known positions to determine its own two-dimensional position relative to the satellites. This can be done in a known manner. Additionally, acquiring a fourth satellite signal allows the receiving device to calculate its three dimensional position by the same geometrical calculation in a known manner. The position and velocity data can be updated in real time on a continuous basis by an unlimited number of users.

As shown in FIG. 1, the GPS system 100 comprises a plurality of satellites 102 orbiting about the earth 104. A GPS receiver 106 receives spread spectrum GPS satellite data signals 108 from a number of the plurality of satellites 102. The spread spectrum data signals 108 are continuously transmitted from each satellite 102, the spread spectrum data signals 108 transmitted each comprise a data stream including information identifying a particular satellite 102 from which the data stream originates. The GPS receiver 106 generally requires spread spectrum data signals 108 from at least three satellites 102 in order to be able to calculate a two-dimensional position. Receipt of a fourth spread spectrum data signal enables the GPS receiver 106 to calculate, using a known technique, a three-dimensional position.

Turning to FIG. 2, a navigation device 200 comprising or coupled to the GPS receiver device 106, is capable of establishing a data session, if required, with network hardware of a “mobile” or telecommunications network via a mobile device (not shown), for example a mobile telephone, PDA, and/or any device with mobile telephone technology, in order to establish a digital connection, for example a digital connection via known Bluetooth technology. Thereafter, through its network service provider, the mobile device can establish a network connection (through the Internet for example) with a server 150. As such, a “mobile” network connection can be established between the navigation device 200 (which can be, and often times is, mobile as it travels alone and/or in a vehicle) and the server 150 to provide a “real-time” or at least very “up to date” gateway for information.

The establishing of the network connection between the mobile device (via a service provider) and another device such as the server 150, using the Internet for example, can be done in a known manner. In this respect, any number of appropriate data communications protocols can be employed, for example the TCP/IP layered protocol. Furthermore, the mobile device can utilize any number of communication standards such as CDMA2000, GSM, IEEE 802.11a/b/c/g/n, etc.

Hence, it can be seen that the internet connection may be utilised, which can be achieved via data connection, via a mobile phone or mobile phone technology within the navigation device 200 for example.

Although not shown, the navigation device 200 may, of course, include its own mobile telephone technology within the navigation device 200 itself (including an antenna for example, or optionally using the internal antenna of the navigation device 200). The mobile phone technology within the navigation device 200 can include internal components, and/or can include an insertable card (e.g. Subscriber Identity Module (SIM) card), complete with necessary mobile phone technology and/or an antenna for example. As such, mobile phone technology within the navigation device 200 can similarly establish a network connection between the navigation device 200 and the server 150, via the Internet for example, in a manner similar to that of any mobile device.

For telephone settings, a Bluetooth enabled navigation device may be used to work correctly with the ever changing spectrum of mobile phone models, manufacturers, etc., model/manufacturer specific settings may be stored on the navigation device 200 for example. The data stored for this information can be updated.

In FIG. 2, the navigation device 200 is depicted as being in communication with the server 150 via a generic communications channel 152 that can be implemented by any of a number of different arrangements. The communication channel 152 generically represents the propagating medium or path that connects the navigation device 200 and the server 150. The server 150 and the navigation device 200 can communicate when a connection via the communications channel 152 is established between the server 150 and the navigation device 200 (noting that such a connection can be a data connection via mobile device, a direct connection via personal computer via the internet, etc.).

The communication channel 152 is not limited to a particular communication technology. Additionally, the communication channel 152 is not limited to a single communication technology; that is, the channel 152 may include several communication links that use a variety of technology. For example, the communication channel 152 can be adapted to provide a path for electrical, optical, and/or electromagnetic communications, etc. As such, the communication channel 152 includes, but is not limited to, one or a combination of the following: electric circuits, electrical conductors such as wires and coaxial cables, fibre optic cables, converters, radio-frequency (RF) waves, the atmosphere, free space, etc. Furthermore, the communication channel 152 can include intermediate devices such as routers, repeaters, buffers, transmitters, and receivers, for example.

In one illustrative arrangement, the communication channel 152 includes telephone and computer networks. Furthermore, the communication channel 152 may be capable of accommodating wireless communication, for example, infrared communications, radio frequency communications, such as microwave frequency communications, etc. Additionally, the communication channel 152 can accommodate satellite communication.

The communication signals transmitted through the communication channel 152 include, but are not limited to, signals as may be required or desired for given communication technology. For example, the signals may be adapted to be used in cellular communication technology such as Time Division Multiple Access (TDMA), Frequency Division Multiple Access (FDMA), Code Division Multiple Access (CDMA), Global System for Mobile Communications (GSM), etc. Both digital and analogue signals can be transmitted through the communication channel 152. These signals may be modulated, encrypted and/or compressed signals as may be desirable for the communication technology.

The server 150 includes, in addition to other components which may not be illustrated, a processor 154 operatively connected to a memory 156 and further operatively connected, via a wired or wireless connection 158, to a mass data storage device 160. The mass storage device 160 contains a store of navigation data and map information, and can again be a separate device from the server 150 or can be incorporated into the server 150. The processor 154 is further operatively connected to transmitter 162 and receiver 164, to transmit and receive information to and from navigation device 200 via communications channel 152. The signals sent and received may include data, communication, and/or other propagated signals. The transmitter 162 and receiver 164 may be selected or designed according to the communications requirement and communication technology used in the communication design for the navigation system 200. Further, it should be noted that the functions of transmitter 162 and receiver 164 may be combined into a single transceiver.

As mentioned above, the navigation device 200 can be arranged to communicate with the server 150 through communications channel 152, using transmitter 166 and receiver 168 to send and receive signals and/or data through the communications channel 152, noting that these devices can further be used to communicate with devices other than server 150. Further, the transmitter 166 and receiver 168 are selected or designed according to communication requirements and communication technology used in the communication design for the navigation device 200 and the functions of the transmitter 166 and receiver 168 may be combined into a single transceiver as described above in relation to FIG. 2. Of course, the navigation device 200 comprises other hardware and/or functional parts, which will be described later herein in further detail.

Software stored in server memory 156 provides instructions for the processor 154 and allows the server 150 to provide services to the navigation device 200. One service provided by the server 150 involves processing requests from the navigation device 200 and transmitting navigation data from the mass data storage 160 to the navigation device 200. Another service that can be provided by the server 150 includes processing the navigation data using various algorithms for a desired application and sending the results of these calculations to the navigation device 200.

The server 150 constitutes a remote source of data accessible by the navigation device 200 via a wireless channel. The server 150 may include a network server located on a local area network (LAN), wide area network (WAN), virtual private network (VPN), etc.

The server 150 may include a personal computer such as a desktop or laptop computer, and the communication channel 152 may be a cable connected between the personal computer and the navigation device 200. Alternatively, a personal computer may be connected between the navigation device 200 and the server 150 to establish an internet connection between the server 150 and the navigation device 200.

The navigation device 200 may be provided with information from the server 150 via information downloads which may be periodically updated automatically or upon a user connecting the navigation device 200 to the server 150 and/or may be more dynamic upon a more constant or frequent connection being made between the server 150 and navigation device 200 via a wireless mobile connection device and TCP/IP connection for example. For many dynamic calculations, the processor 154 in the server 150 may be used to handle the bulk of processing needs, however, a processor (not shown in FIG. 2) of the navigation device 200 can also handle much processing and calculation, oftentimes independent of a connection to a server 150.

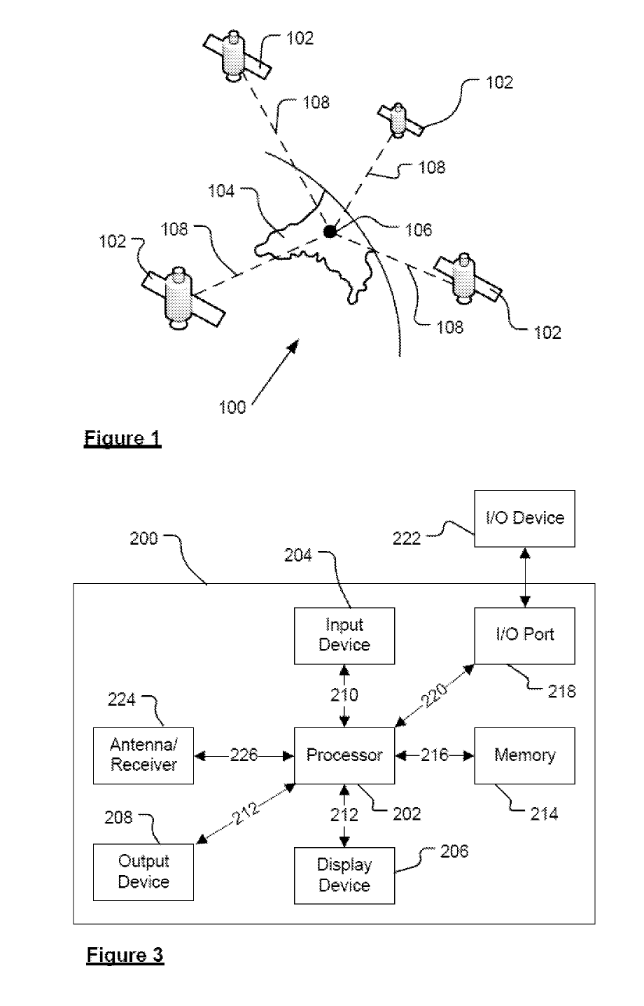

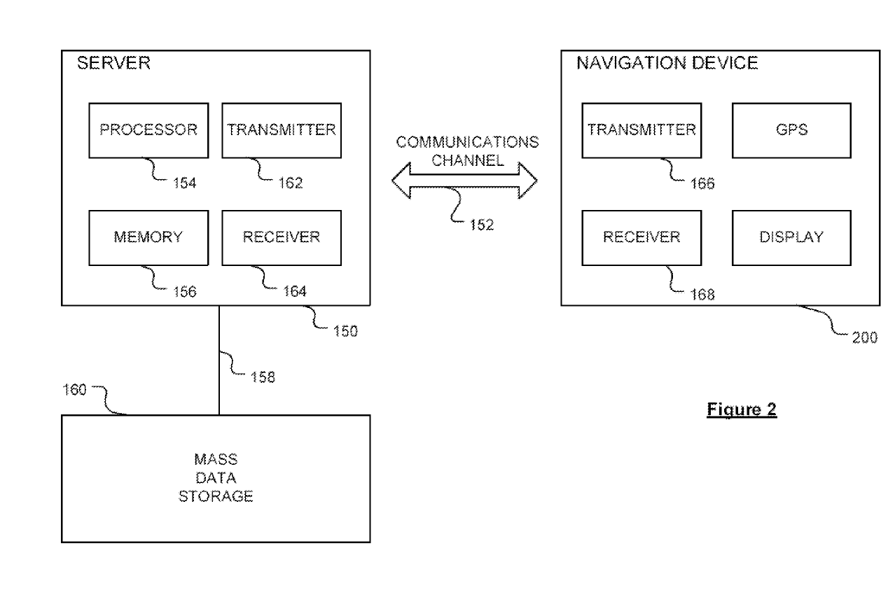

Referring to FIG. 3, it should be noted that the block diagram of the navigation device 200 is not inclusive of all components of the navigation device, but is only representative of many example components. The navigation device 200 is located within a housing (not shown). The navigation device 200 includes a processing resource comprising, for example, the processor 202 mentioned above, the processor 202 being coupled to an input device 204 and a display device, for example a display screen 206. Although reference is made here to the input device 204 in the singular, the skilled person should appreciate that the input device 204 represents any number of input devices, including a keyboard device, voice input device, touch panel and/or any other known input device utilised to input information. Likewise, the display screen 206 can include any type of display screen such as a Liquid Crystal Display (LCD), for example.

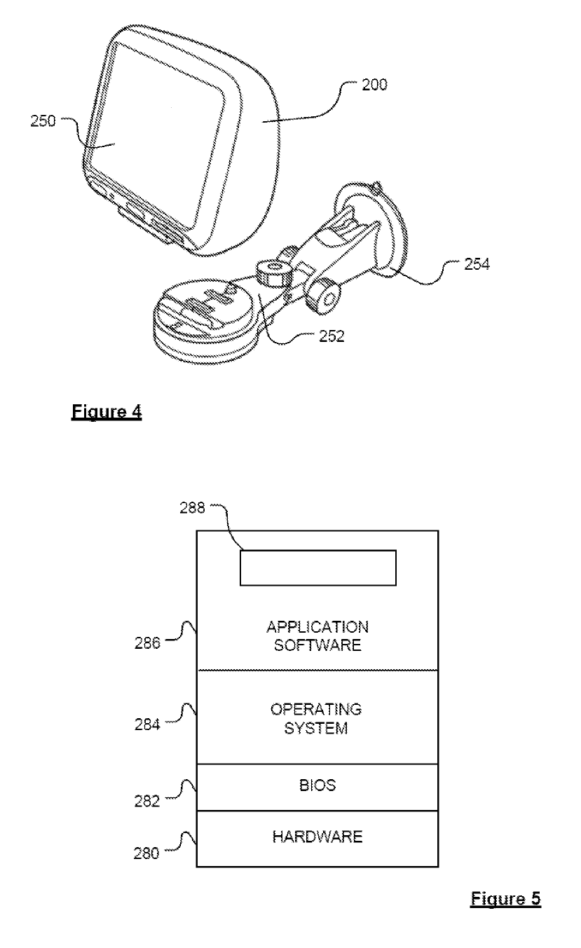

In one arrangement, one aspect of the input device 204, the touch panel, and the display screen 206 are integrated so as to provide an integrated input and display device, including a touchpad or touchscreen input 250 (FIG. 4) to enable both input of information (via direct input, menu selection, etc.) and display of information through the touch panel screen so that a user need only touch a portion of the display screen 206 to select one of a plurality of display choices or to activate one of a plurality of virtual or “soft” buttons. In this respect, the processor 202 supports a Graphical User Interface (GUI) that operates in conjunction with the touchscreen.

In the navigation device 200, the processor 202 is operatively connected to and capable of receiving input information from input device 204 via a connection 210, and operatively connected to at least one of the display screen 206 and the output device 208, via respective output connections 212, to output information thereto. The navigation device 200 may include an output device 208, for example an audible output device (e.g. a loudspeaker). As the output device 208 can produce audible information for a user of the navigation device 200, it is should equally be understood that input device 204 can include a microphone and software for receiving input voice commands as well. Further, the navigation device 200 can also include any additional input device 204 and/or any additional output device, such as audio input/output devices for example.

The processor 202 is operatively connected to memory 214 via connection 216 and is further adapted to receive/send information from/to input/output (I/O) ports 218 via connection 220, wherein the I/O port 218 is connectable to an I/O device 222 external to the navigation device 200. The external I/O device 222 may include, but is not limited to an external listening device, such as an earpiece for example. The connection to I/O device 222 can further be a wired or wireless connection to any other external device such as a car stereo unit for hands-free operation and/or for voice activated operation for example, for connection to an earpiece or headphones, and/or for connection to a mobile telephone for example, wherein the mobile telephone connection can be used to establish a data connection between the navigation device 200 and the Internet or any other network for example, and/or to establish a connection to a server via the Internet or some other network for example.

FIG. 3 further illustrates an operative connection between the processor 202 and an antenna/receiver 224 via connection 226, wherein the antenna/receiver 224 can be a GPS antenna/receiver for example. It should be understood that the antenna and receiver designated by reference numeral 224 are combined schematically for illustration, but that the antenna and receiver may be separately located components, and that the antenna may be a GPS patch antenna or helical antenna for example.

It will, of course, be understood by one of ordinary skill in the art that the electronic components shown in FIG. 3 are powered by one or more power sources (not shown) in a conventional manner. As will be understood by one of ordinary skill in the art, different configurations of the components shown in FIG. 3 are contemplated. For example, the components shown in FIG. 3 may be in communication with one another via wired and/or wireless connections and the like. Thus, the navigation device 200 described herein can be a portable or handheld navigation device 200.

In addition, the portable or handheld navigation device 200 of FIG. 3 can be connected or “docked” in a known manner to a vehicle such as a bicycle, a motorbike, a car or a boat for example. Such a navigation device 200 is then removable from the docked location for portable or handheld navigation use.

Referring to FIG. 4, the navigation device 200 may be a unit that includes the integrated input and display device 206 and the other components of FIG. 2 (including, but not limited to, the internal GPS receiver 224, the microprocessor 202, a power supply (not shown), memory systems 214, etc.).

The navigation device 200 may sit on an arm 252, which itself may be secured to a vehicle dashboard/window/etc. using a suction cup 254. This arm 252 is one example of a docking station to which the navigation device 200 can be docked. The navigation device 200 can be docked or otherwise connected to the arm 252 of the docking station by snap connecting the navigation device 200 to the arm 252 for example. The navigation device 200 may then be rotatable on the arm 252. To release the connection between the navigation device 200 and the docking station, a button (not shown) on the navigation device 200 may be pressed, for example. Other equally suitable arrangements for coupling and decoupling the navigation device 200 to a docking station are well known to persons of ordinary skill in the art.

Turning to FIG. 5, the processor 202 and memory 214 cooperate to support a BIOS (Basic Input/Output System) 282 that functions as an interface between functional hardware components 280 of the navigation device 200 and the software executed by the device. The processor 202 then loads an operating system 284 from the memory 214, which provides an environment in which application software 286 (implementing some or all of the above described route planning and navigation functionality) can run. The application software 286 provides an operational environment including the GUI that supports core functions of the navigation device, for example map viewing, route planning, navigation functions and any other functions associated therewith. In this respect, part of the application software 286 comprises a view generation module 288.

FIG. 6 shows an embodiment in which the navigation device 200 is installed in a vehicle and is operatively linked to a image recording device 300. The image recording device 300 comprises a camera, in this case a video camera 302, and a memory 304. In variants of the embodiment, the image recording device is incorporated in the navigation device 200. Various components of the navigation device are shown in FIGS. 2 and 3, and those components are omitted from FIG. 6 for clarity.

The navigation device 200 is able to communicate with the server 150 through the communication channel 152. The server includes a processor 154 as shown in FIG. 2, and the processor includes various modules including an incident monitoring module 306 and a video data processing module 308.

The processor 202 of the navigation device 200 is able to control operation of the video recording device 300. In particular the processor 202 is able to control the starting and stopping of recording, the storage of the video data and the transmission of video data using the transmitter 166 and receiver 168.

In the ordinary course of operation, the video recording device is instructed to record data continuously, either to memory 214 or to the memory 304 included in the device itself. The memory 214 is assigned so that only a limited amount of recorded video data is stored and therefore, in this mode of operation, all of the data is constantly overwritten in a first in/first out basis.

The apparatus of FIG. 6 is configured so that video data relating to an incident, in particular a traffic incident such as an accident, may be obtained and processed.

In a first mode of operation, the incident monitoring module 306 included in the server 150 is notified of a possible traffic incident at a particular location. The server may be notified by an external agency, for instance a police or traffic control computer, or may determine that there has been an incident based on a signal obtained from one or more navigational apparatuses as discussed in more detail below.

In response to notification of the incident, the incident monitoring module generates an incident signal and transmits the incident signal to the navigation apparatus 200 if it knows that the navigation apparatus 200 is in the vicinity of the incident. That mode of operation is particularly applicable to the case where navigation apparatuses transmit their location to the server 150 regularly and where the server 150 monitors the location of the navigation apparatuses. The incident signal in that case includes navigation apparatus identifiers identifying the apparatuses for which it is intended and the navigation apparatuses are configured so that only those apparatuses identified in the incident signal carry out a video data processing operation in response to the incident signal.

The incident signal is received by the navigation apparatus via the receiver 168 and is passed to the processor 202. The processor 202 initiates a video data processing operation in response to the incident signal. In this example the video data processing operation comprises the streaming of the video data from the video recording device back to the server 150 via the navigation device 200.

In another example, the processor instructs the video recording device to begin recording video if it is not doing so already, or instructs the video recording device to transmit all video data that has already been recorded back to the server 150. The processor 202 may also instruct the video recording device to retain already recorded video data and thus overrides the overwriting of that video data in accordance with a first in/first out procedure.

In another mode of operation, the server transmits the incident signal to all navigation apparatuses within range and includes a location identifier that identifies the location of the incident. Each navigation apparatus then determines whether it is close to the incident location and processes the incident signal accordingly. Usually only those navigation apparatuses within a predetermined distance (which predetermined distance can be notified to the apparatuses in the incident signal) of the incident location carry out a video data processing operation in response to the incident signal. In an alternative mode of operation, all navigation apparatuses that receive an incident signal perform the video data processing operation in response to the incident signal, regardless of their location or identity. In that case the video data is post-processed by the server 150 to select video data that is of relevance.

The processor 202 may also increase the amount of memory allocated to storage of video data in response to receipt of the incident signal to ensure that already recorded data is not overwritten.

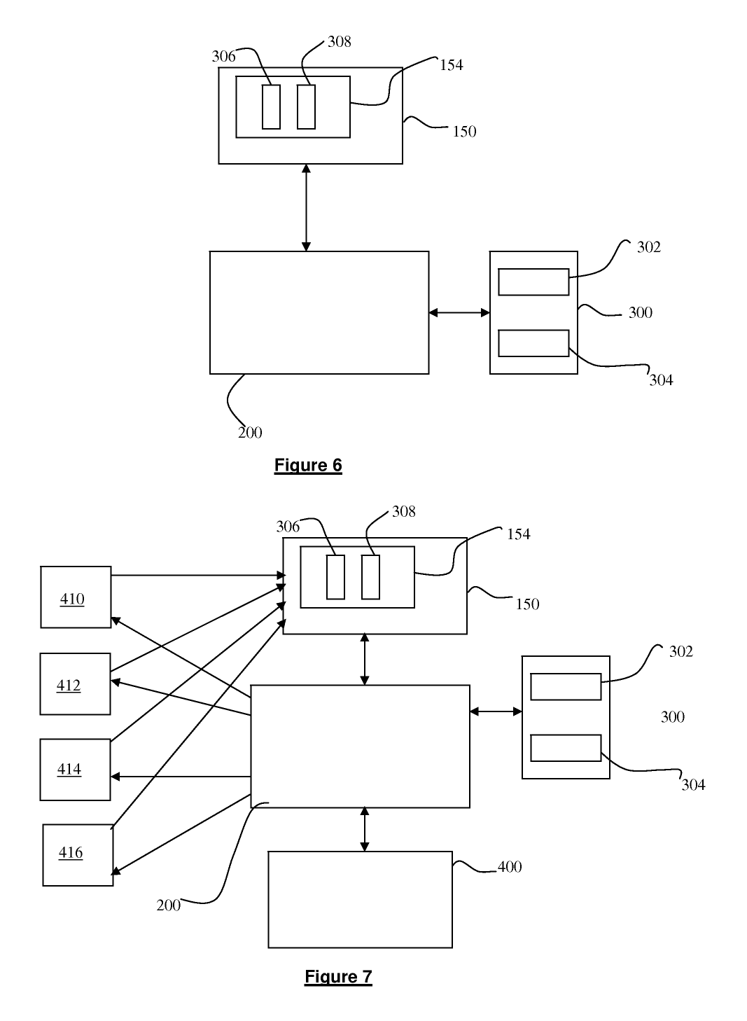

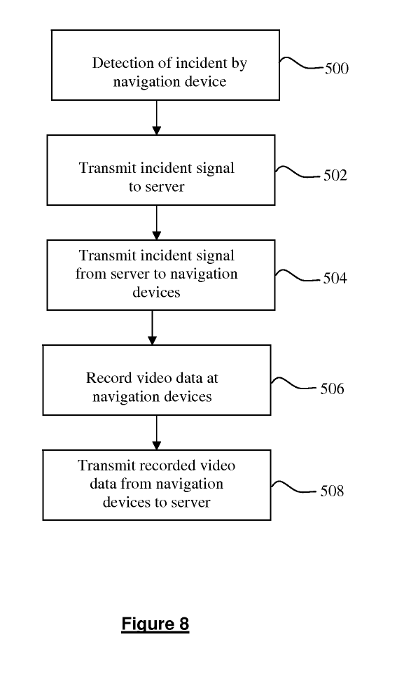

FIG. 7 shows a variant of the navigation system of FIG. 6. The navigation apparatus 200 is installed in a vehicle and is appropriately connected to the video recording device 300 and is in communication with the server 150. According to this variant, the navigation apparatus 200 is also connected to detection circuitry 400 that detects the motion of the vehicle. The detection circuitry 400 comprises an accelerometer linked to processing circuitry. The detection circuitry is configured to detect abnormal movement of the vehicle, for instance a sharp acceleration, a sharp deceleration, an abnormal turn, a skid or a shock. Upon detection of such an abnormal movement, it detects an incident signal and transmits the incident signal to the processor 202 of the navigation device 200. In this example the navigation device 200 is configured to treat the incident signal as a control signal and performs a video data processing operation as described above.

The navigation apparatus 200 transmits the incident signal to at least one other navigation apparatus 410 412 414 416 directly, instead of or in addition to transmitting the incident signal to the server 150. If the other navigational apparatuses 410 412 414 416 are suitably configured they perform a video data processing operation in response to the incident signal. Thus, a navigation apparatus on board a vehicle can instruct navigation apparatuses 410 412 414 416 in other vehicles in the vicinity to begin recording or transmitting video data directly, without instructions first having to be received from the server 150. The navigation apparatuses are usually again configured to transmit video data back to the server 150.

In another mode of operation, the navigation apparatus 200 transmits the incident signal to the server 150 via the transmitter 166 on communication channel 152. The server 150 receives the incident signal and determines than an incident has taken place at the location of the navigation device 200. The server 150 then either retransmits the incident signal, or transmits a further incident signal, to the other navigation apparatuses in the vicinity of the incident or generates, to instruct them to perform a video data processing operation. Thus, again, video data may be obtained from more than one vehicle in the vicinity of an incident.

The video data received by the server 150 from one or more navigation apparatuses in response to occurrence of an incident is processed by the video data processing module 308. In the simplest example the video data is merely stored and may be made available to the police, insurance companies or other interested parties as appropriate. Alternatively the video data is also edited or further processed further at the server 150.

In one example, the video data processing module 308 includes an image recognition module, for instance a vehicle or plate recognition module running image processing software. The image recognition module is configured to process video data received from navigation apparatuses in the vicinity of an incident in order to identify vehicles, vehicle types or number plates.

The server 150 generates a vehicle identifier representative of an identified vehicle, vehicle type or number plate and instructs the image recognition module to scan video data received from other locations subsequent to the incident in order to track progress of one or more vehicles that may be associated with the incident.

In another variant, the image recognition module is included in the navigation apparatus 200 as well as or instead of the server 150. In this variant, the navigation apparatus 200 is able to identify a vehicle, vehicle type or number plate itself and to generate a vehicle identifier. The vehicle identifier can then be transmitted to the server 150. The vehicle identifier can then be used in tracking a vehicle, for instance by processing video data received from other navigation apparatuses at different locations.

The navigation apparatus 200 can also be linked to a central processing unit of a vehicle and/or one or more measurement devices on a vehicle that measure one or more environmental or operational parameters, for example one or more of light level, speed, temperature, weather condition or operation of the vehicle or a component of the vehicle. Measurement data from the measurement devices or central processing unit is sent to the navigation device 200 and may be transmitted to the server 150 in association with the video data. Thus, further data concerning an incident, such as a traffic accident, may be obtained.

One mode of operation of the embodiments describe above is illustrated in the flow chart of FIG. 8.

Once an accident occurs at a particular location, the embodiments described above can be used to enable video footage from surrounding vehicles to be used for evidence gathering. After the accident the server 150 is able to request that the navigation devices 200 keep the video data and send it to the server 150. The request may be sent to the navigation devices over the air or through any type of connection. As described above, the server may know about the accident because navigation devices in the vicinity register accident characteristics such as sharp changes in speed.

The call to start recording (or to not delete video data or other images) may come from other navigation devices. The system can also be configured to register another plate in the vicinity of the incident and have all navigation devices on the road track where they were after leaving the scene of the incident.

The navigation devices in the vicinity of the road accident may already be recording data but normally this would be thrown out after a particular time period to save space. However, the navigation devices may be instructed to keep the data and send it to a server for analysis. In this way the footage from multiple sources from before, during and after the accident is available. Video recording devices associated with navigation devices are even able to record footage from the opposite direction of travel from the other side of the road to the incident. Navigation devices can also record any other available telemetric data as well (for example speed, lighting conditions, temperature, CANbus information). If needed, quick number plate recognition can tell all devices in a larger area to look for a particular number plate and/or to track or record when the number plate was last seen or where the vehicle drove to.

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the present invention may be exemplified as a portable navigation device, it would be appreciated that route planning and navigation functionality may also be provided by a desktop or mobile computing resource running appropriate software. For example, the Royal Automobile Club (RAC) provides an on-line route planning and navigation facility at http://www.rac.co.uk, which facility allows a user to enter a start point and a destination whereupon the server with which the user's computing resource is communicating calculates a route (aspects of which may be user specified), generates a map, and generates a set of exhaustive navigation instructions for guiding the user from the selected start point to the selected destination.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example, microwave or infrared. The series of computer instructions can constitute all or part of the functionality described above, and can also be stored in any memory device, volatile or non-volatile, such as semiconductor, magnetic, optical or other memory device.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

It will be understood that the present invention has been described above purely by way of example, and modifications of detail can be made within the scope of the invention.

Each feature disclosed in the description, and (where appropriate) the claims and drawings may be provided independently or in any appropriate combination.

1. A navigation apparatus comprising:—
an image recording device for recording image data; and
a processing resource configured to receive an incident signal indicative of the occurrence of an incident and to perform an image data processing operation in response to the incident signal.

2. Apparatus according to claim 1, wherein the image data processing operation comprises a transmission or recording operation.

3. Apparatus according to claim 2, wherein the transmission or recording operation comprises at least one of transmitting image data to a server, recording image data and retaining recorded image data.

4. Apparatus according to claim 1, further comprising detection circuitry for detecting the occurrence of the or an incident, and for generating the or an incident signal in response to the occurrence of the or an incident.

5. Apparatus according to claim 4, wherein the navigation apparatus is installed in a vehicle, and the detection circuitry is arranged to detect movement of the vehicle, and to generate the incident signal in response to a movement of the vehicle.

6. Apparatus according to claim 4, configured to transmit the incident signal at least one of to a server and to at least one other navigation apparatus.

7. Apparatus according to claim 1, wherein the processing resource is configured to at least one of record and transmit further data in response to the incident signal.

8. Apparatus according to claim 1, further comprising a vehicle or number plate recognition module, wherein the incident signal comprises a vehicle identifier, and the image data processing operation comprises instructing the vehicle or number plate recognition module to analyse the image data for the presence of a vehicle or number plate in dependence upon the vehicle identifier.

9. A server comprising an incident monitoring module configured to transmit an incident signal to at least one navigation apparatus in response to the occurrence of an incident, the incident signal being for initiating an image data processing operation at the at least one navigation apparatus.

10. A server according to claim 9, configured to receive image data from the at least one navigation apparatus and to process the image data in response to the occurrence of the incident.

11. A server according to claim 10, further comprising a vehicle or number plate recognition module, wherein the processing of the image data comprises analysing the image data by the vehicle or number plate recognition module to identify at least one vehicle or number plate associated with the incident.

12. A server according to claim 10, wherein the processing of the image data comprises processing image data to track the identified vehicle or number plate.

13. A navigation system comprising a server comprising an incident monitoring module configured to transmit an incident signal in response to the occurrence of an incident, and at least one navigation apparatus, the or each navigation apparatus comprising an image recording device for recording image data and a processing resource configured to receive the incident signal and to perform an image data processing operation in response to the incident signal

14. A method of monitoring the scene of an incident comprising recording image data using at least one navigation apparatus at the scene of the incident.

15. A method according to claim 14, further comprising transmitting the recorded image data from the or each navigation apparatus to a server.

16. A non-transitory computer readable medium comprising computer executable instructions for, when executed on a computer, performing a method according to claim 14.
